(19) United States
(12) Patent Application Publication
(10) Pub. No.: US 2005/0087937 A1
(43) Pub. Date: Apr. 28, 2005

(54) Lock type manually tightened chuck

(76) Inventor: Wenhua Zhou, Taizhou (CN)

Correspondence Address: G. LINK CO., LTD, 931 WEST 75TH STREET, SUITE 137 PMB 174, NAPERVILLE, IL, 60565, US

(21) Appl. No.: 10/693,515

(22) Filed: Oct. 22, 2003

(51) Int. Cl. B23B 31/10; B23B 31/12; B25G 3/02; B23B 5/22

(52) U.S. Cl. 279/62

(57) ABSTRACT

A lock type manually tightened chuck includes a front cover, an inner cover, a driving nut and a chuck body. The front cover is located at the front side of chuck body. The driving nut is fixed to the chuck body in the middle part thereof. A plurality of thin pillars are fixedly attached to the inner cover circumferentially. A plurality of elastic pallets at an end thereof respectively connect with the thin pillar firmly, and the other ends of the pallets has a stick-up respectively. The inner cover is fixedly set around the driving nut. The front cover at the inner wall thereof has a plurality of recesses and each of the recesses has two lateral walls with one of the lateral walls contacting the walls of the thin pillars and the other lateral walls are disposed at the pick-ups of the pallets to lean against each other. A set of ratchets is disposed at the chuck body evenly to correspond to the pallets. The lock type manually tightened chuck can prevent the drill from loosening when it is in work and can be used under being frequently subjected to impact loads.

### BACKGROUND OF THE INVENTION

1. Field of the Invention

The present invention relates to a chuck used in mechanical work equipment, and, particularly, to a lock type manually tightened chuck in a drill press for the drill being operated without loosening.

2. Description of Related Art

Generally, a manually tightened chuck includes a front cover, a back cover, a driving nut, a chuck body and a clamp. Chinese Utility Model published number CN2322725Y discloses a manually tightened chuck, which includes a driving nut, a chuck body, three clamps, a front cover and a back cover. The clamps mount in three inclined holes equally distributed in the chuck body. The clamps engage with the driving nut by way of screws. A thrust bearing is set at the back end of the driving nut. A stop ring is provided at the back end of the thrust bearing. A back cover is set at the back end of the chuck body. The driving nut has a structure of two half parts and the two half parts are joined to each other while the driving nut passes through a cap so that the driving nut can fit with the cap tightly. A key is used to connect the front cover and the cap together so that torque generated can be transmitted.

The friction torque, which has to be overcome, resulting from relative rotation between the driving nut and the chuck body includes rolling friction torque generating from balls of the thrust bearing rolling between the driving nut and the chuck body, gliding friction torque produced between the driving nut and the chuck body. Hence, friction torque occurs during the relative rotation between the driving nut and the chuck body is relatively less.

When the manually tightened chuck is subjected to impact load or severe load, it generates relative running between the driving nut and the chuck body and the anti-shock capability of the chuck is reduced. As a result, the drill held by the chuck becomes slip or loosening to affect the normal production work.

### SUMMARY OF THE INVENTION

An object of the present invention is to provide a new manually tightened chuck that does't loosen in shock condition to overcome the deficiency of the prior art.

Accordingly, the manually tightened chuck according to the present invention includes a front cover, an inner cover a driving nut and a chuck body. The inner cover is set at the foreside of the chuck body. The driving nut is set in the middle of chuck body. A plurality of thin pillars are fixed to the inner cover circumferentially. A plurality of elastic pallets are attached to the thin pillars in a way of the elastic pallets having a respective end thereof connecting with the thin pillars and the other end of each elastic pallet has a stick-up. The inner cover is fixedly set on the outer wall of the driving nut. The front cover at the inner wall surface thereof is provided with a plurality of grooves corresponding to the thin pillars and the elastic pallets. Each of the grooves has two opposite lateral walls and one of the lateral walls contacts with a lateral wall of a corresponding thin pillar with the other lateral wall being disposed at the pick-up of a corresponding elastic pallet so as to lean against each other with the corresponding elastic pallet. A set of ratchets is circumferentially mounted to the chuck body evenly and the ratchets are disposed to correspond to positions of the pallets.

Due to the ratchets being evenly disposed around the chuck body, once the chuck is in a state of being tightened, part of the elastic pallets engage with the ratchets. In this way, it is not easy for the driving nut to occur rotation with respect to the chuck body, that is, jaws of the chuck do not occur slip relative to the chuck body such that the drill is incapable of becoming loose and it greatly enhances the reliability of safety while the chuck is I operation.

### BRIEF DESCRIPTION OF THE DRAWINGS

The detail structure, the applied principle, the function and the effectiveness of the present invention can be more fully understood by referring to the following description and accompanying drawings, in which:

FIG. 1 is a plan view of the manually tightened chuck according to a first embodiment of the present invention;

FIG. 2 is a sectional view along line 2-2 in FIG. 1;

FIG. 3 is a perspective view of an inner cap in the chuck shown in FIG. 1;

FIG. 4 is a sectional view illustrating the chuck shown in FIG. 1 in a condition of lock.

FIG. 5 is a sectional view of the manually tightened chuck according to a second embodiment of the present invention; and

FIG. 6 is a perspective view of an inner cap in FIG. 5.

### DETAILED DESCRIPTION OF THE PREFERRED EMBODIMENTS

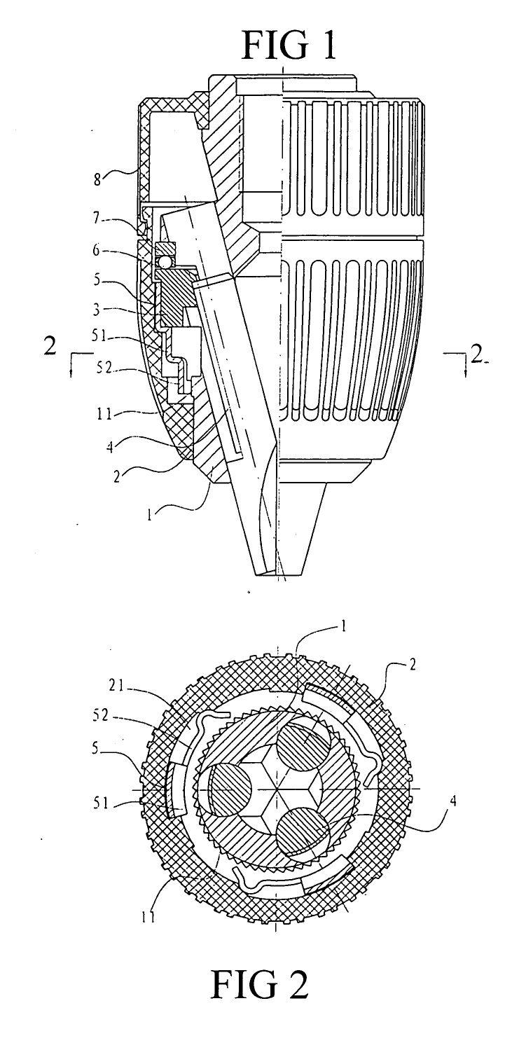

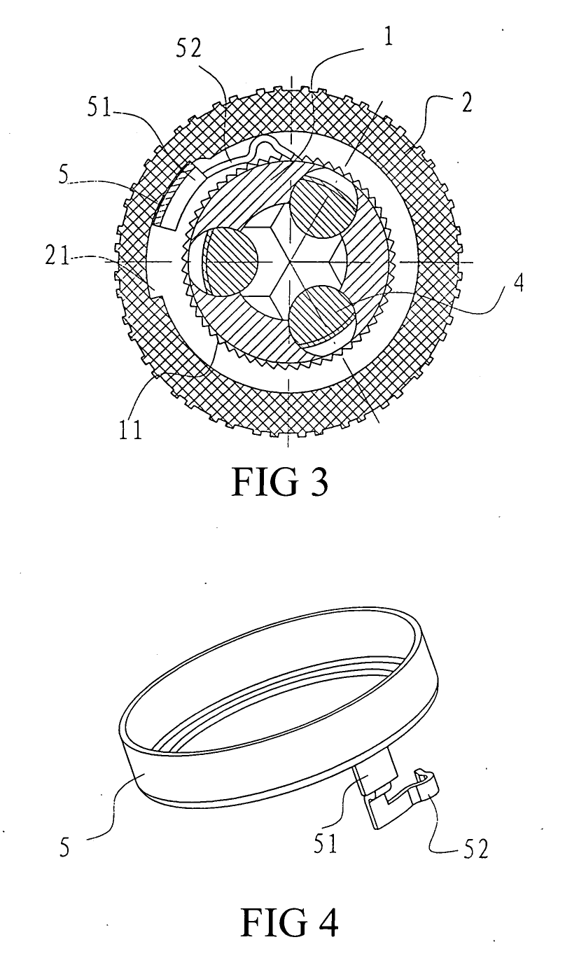

Referring to FIGS. 1 and 2, the manually tightened chuck of an embodiment according to the present invention is illustrated. The manually tightened chuck of the embodiment includes a chuck body 1 and there are three equidistant inclined holes disposed in the chuck body 1 circumferentially. Each of the inclined holes slidably fits with a jaw 4 respectively. A driving nut 3 is mounted in the middle of chuck body 1 engages with the jaws 4 by thread screws. A front cover 2 is disposed at the front side of the chuck body 1, and a back cover 8 is disposed at the back of the chunk body 1. The front cover 2 is joined to the back cover 8 by way of structure of projection and annular recess arranged at the front cover 2 and the back cover 8 respectively. A thrust bearing 6 with a washer 7 is disposed between the top of driving nut 3 and the middle of chuck body 1 to secure the driving nut 3 freely rotating relative to the chuck body 1. An inner cover 5 is attached to the outside of the driving nut 3 and it can be seen in FIG. 3 that a plurality of thin pillars 51 are disposed around the inner cover 5. It is provided with a plurality of elastic pallets 52 corresponding to the thin pillars 51 and each of the elastic pallets 52 at an end thereof is fixedly connected to one corresponding thin pillar 51 and at another end thereof has a stick-up. The inner cover 5 fits with the driving nut 3 tightly. The front wall 2 at the inner wall surface thereof is provided with a plurality of recesses 21 and the recesses 21 are disposed corresponding to both the thin pillars 51 and the elastic pallets 52. Each of the recesses 21 at a lateral side thereof contacts with a lateral side of a corresponding thin pillar 51 and at another lateral side thereof is disposed at the pick-up of a corresponding elastic pallet 52 such that the elastic pallets 52 lean against the thin pillars 51. In order to improve capability of being subjected to impacts for the recesses 21 and the elastic pallets 52, a circular surface can be made at the upper part of the lateral side in each recess 21, which contact with the elastic pallets 52. There is a set of ratchets 11 disposed at the top of the chuck body 1 evenly and around the chuck body 1 corresponding to the elastic pallets 52.

It is noted that the elastic pallets 52 can be secured to the thin pillars 51 with riveting or welding. The elastic pallet 52 can be made of spring steel and the thin pillars 51 can be made of regular carbon steel such as A3 steel.

The operation of the manually tightened chuck is explained hereinafter.

First, fix the manually tightened chuck to the spindle of a drill press tightly, and, then, insert the chuck into an opening among three pallets 4, and, next, engage the front cover 2 long screw thread direction. At this time, the recesses 21 at a respective lateral wall thereof can lean against the elastic pallets 52. When the anti distortion moment produced by elastic pallets 52 is not less than the torque exerting to the front cover 2, the front cover 2 drives the inner cover 5 to rotate. Because the inner cover 5 tightly fits with the driving nut 3, the driving nut 3 and the inner cover 5 rotate together. Hence, the three jaws 4 move downwards at the same time, and the opening confined by the three jaws 4 become less gradually so that the three jaws 4 can clamp the drill tightly. The torque for rotating the front cover 2 increases gradually during the drill being clamped. When the torque is greater than the anti distortion moment produced by elastic pallets 52, the elastic pallets 52 produce elastic deformation and the pick-ups are raised away from recesses 21. In this way, the ends of elastic pallets 52 engage with the ratchets of chuck body 1 and the front covers 2 rotate continuously. At this time, due to the elastic pallets 52 engaging with the ratchets 11, the inner cover 5 does not moves with the front cover 2 any more. When the front cover 2 rotates a certain angle relative to the inner cover 5, another lateral wall of the respective recess 21 touches the corresponding lateral wall of the respective thin pillar 51. Under a push force being exerted to the thin pillars 51 from the recesses 21, the end parts of the elastic pallets 52 deforms and moves away from the ratchets 11 such that the inner cover 5 and driving nut 3 continue to rotate relative to the chuck body 1 with the front cover 2 until the jaws 4 clamp the drill completely as shown in FIG. 4. When the elastic pallets 52 engage with the ratchets 11, the driving nut 3 and chuck body 1 can be fastened to each other and drilling work can be started to run safely.

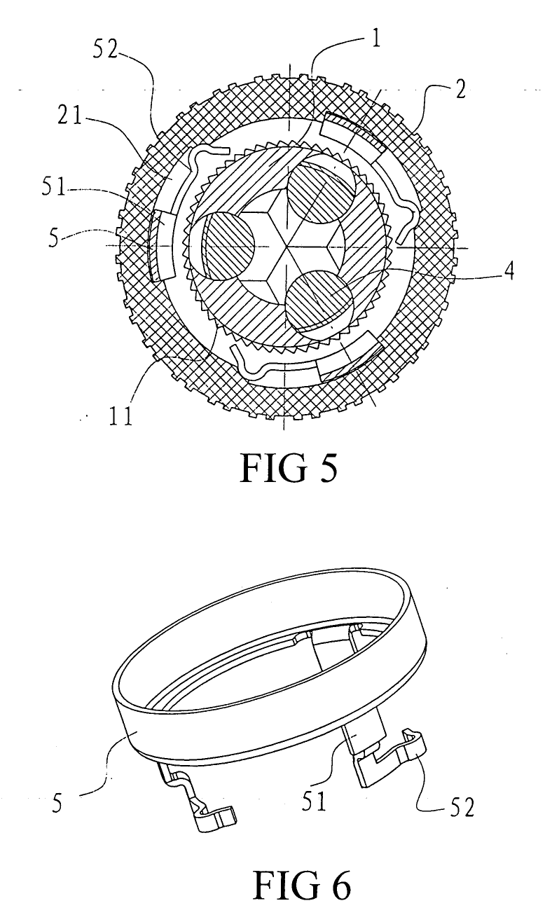

Referring to FIGS. 5 and 6, a second embodiment of the present invention illustrated. It can be seen in FIGS. 5 and 6 that three thin pillars 51 are evenly arranged surrounding the lower part of the inner cover 5. The thin pillars 51 are fixedly joined to the elastic pallets 52 respectively and, accordingly, the three recesses 21 are provided around the front cover 2. The second embodiment allows the manually tightened chuck of the present invention to be subjected to a force evenly during working such that better clamping effect can be obtained effectively.

While the invention has been described with referencing to preferred embodiments thereof, it is to be understood that modifications or variations may be easily made without departing from the spirit of this invention, which is defined by the appended claims.

1. A lock type manually tightened chuck, comprising:
a chuck body with a front side and a back side;
a front cover, being fixed to the front side of the chuck; and
a driving nut, being fixed to a middle part of the chuck;
characterized in that the manually tightened chuck further comprises an inner cover, a plurality of thin pillar, which is fixedly attached to the inner cover circumferentially, a plurality of elastic pallets, being corresponding to the thin pillars and each of the elastic pallets at one end thereof connecting with a corresponding one of the thin pillars fixedly and another end of said elastic pallet being a stick-up; the inner cover is fixedly attached to the driving nut; the front cover at an inner wall thereof is provided with a plurality of recesses and each of the recesses having two opposite lateral walls; the inner walls of the thin pillars contact with one of the lateral walls of the recesses respectively and the other lateral walls of the recesses are disposed at the stick-ups of the pallets to lean against each other; and a set of ratchets are circumferentially provided on the chuck body evenly corresponding to the pallets.

2. The lock type manually tightened chuck according to claim 1, wherein at least two of the thin pillars are disposed to distribute evenly around the chuck body and each of the thin pillars is fixed with one of the elastic pallets.

3. The lock type manually tightened chuck according to claim 1, wherein the lateral wall of each of the recesses disposed at the stick-ups of the pallets has a circular surface at a front half section thereof.
